(19) United States
(12) Patent Application Publication
(10) Pub. No.: US 2012/0125172 A1
(43) Pub. Date: May 24, 2012

(54) CUTTING GRID

(75) Inventors: Javier Hidalgo García, Tolosa (ES); Aitor Aguirrezabalaga Zubizarreta, Azpeitia (ES); Aitor Gogorza Segurota, Azpeitia (ES)

(73) Assignee: SAMMIC, S.L., Azkoitia (ES)

(21) Appl. No.: 13/299,608

(22) Filed: Nov. 18, 2011

(30) Foreign Application Priority Data
Nov. 19, 2010 (ES) 201001159
Jun. 27, 2011 (ES) 201100592

(51) Int. Cl. B26D 1/12

(52) U.S. Cl. 83/676

(57) ABSTRACT

A cutting grid comprises a central cutting central grid element composed of a multiplicity of cutting blades arranged in a framework of quadrangular opening or in parallel with longitudinal passage openings, depending on the cutting desired result, with a central cutting element which is supported around the perimeter by an external frame and in a central position a central grid element incorporates a tubular rim.

### OBJECT OF THE INVENTION

The present invention relates to a grid for cutting vegetables, which provides essential features of novelty and remarkable advantages with regard to the already known and used means for the same purposes in the current state of the art.

More particularly, the invention develops a grid of the kind that is assembled in machines like vegetable choppers or kitchen robots, structured on the basis of a cutting grid, either of the kind that allow cutting vegetables in the form of squares or cubes, or either of the type that allows cutting vegetables in long strips of a predetermined width, surrounded in the perimeter by a plastic material formed by means of an overinjection molding operation as a perimeter and endowed with a reinforcement metal rim in its interior. The cutting grid includes at least two blades of a considerably larger height than the rest of the blades that form the framework of the grid, in order to provide the whole area with a greater rigidity against bending, while the outer perimeter optionally includes positioning lugs integrated in it and radially projected outwards from diametrically opposing positions.

The field of application of the invention is comprised within the industrial sector engaged in the manufacture of machinery for kitchen equipment, such as food slicers, kitchen robots, etc.

### BACKGROUND AND SUMMARY OF THE INVENTION

Diverse vegetable chopping machines, used in kitchens, are known in the state of the art, providing for the cutting of vegetables in a multiplicity of portions, generally with the shape of a square or cube (for example, carrots, potatoes, etc.), or with elongated shapes based on the length of the vegetable and with a predetermined width (for example, strips of potatoes for frying, etc.). These machines generally include a feed tube with an opening for the introduction of the vegetable, either pushed by hand or with a food pusher, so that, as it penetrates, the vegetable is reached by a cutting disc driven by a twisting motion that progressively divides it in slices that, when being cut, are pushed toward a cutting grid formed by cutting blades arranged so that they form a framework as a grid (squared openings), or also the blades run in parallel, mutually separated by a predetermined distance, so that in the first case, the slices of vegetable are divided into squares or cubes when passing through the cutting grid, while in the second case, they are divided into sections or elongated strips of the same length as the slice of the vegetable. The end product is expelled out of the machine with the help of an ejection disc which rotates jointly with the rotation axis of the cutting disc itself, getting out through a product outlet.

In general, current cutting grids are composed by a central grid element formed by a multiplicity of cutting blades that, depending on the desired result, constitute a network of squared or elongated openings, as mentioned above.

This central grid element, normally with a circular shape, is supported by an also circular exterior frame, in which center has a tubular, cylindrical, short formation, which allows the passage of the rotating drive shaft and helps to a centered positioning of the central grid element when it is placed in the interior of the exterior frame and supported on the above mentioned diametric reinforcements.

Thus, the central grid element is attached to the exterior frame without possibility of detaching, while the direct support on the frame allows absorbing the stress resulting from the use of the cutting grid, especially when this is of the type composed by open parallel blades to cut food into longitudinal strips.

Although the cutting grids of the type discussed above perfectly perform the function for which they were developed, the investigations of the applicant have led to the execution of a new version that substantially simplifies the structure of this type of device, at the same time facilitating the productive process, without the resultant cutting grid losing effectiveness or presenting any loss in terms of its operational capacity with respect to the current cutting grids.

A cutting grid with enhanced features is the object of the present invention, as it will be described below.

In essence, the cutting grid proposed by the present invention comprises a central cutting central grid element with characteristics similar to the one incorporated in current grids, composed of a multiplicity of cutting blades arranged in a framework of quadrangular opening or in parallel with longitudinal passage openings, depending on the cutting desired result, but unlike conventional chopping grids it presents the following characteristics:
The central cutting element is supported around the perimeter by an external frame consisting of a circular perimeter of plastic material, formed by an overinjection operation and in which interior, before the operation of the plastic material injection, a metal rim is placed, preferably made of aluminium, in such a way that the external perimeter includes a metal ring embedded in its interior, inserted by injection of the plastic material and designed to prevent the eventual sagging produced by the material retraction during the cooling of the plastic material, thereby ensuring that the cutting blades of the central grid element are kept straight;
Also, in a central position, the central grid element incorporates a tubular rim also made of a plastic material and obtained in the same molding overinjection operation;
Fixing between the central grid element and the external perimeter is performed by incrustation of the respective cutting blades' ends in the perimeter itself during the solidification of said overinjected material;
The central grid element includes two blades of a considerably larger height than the rest of blades that integrate said central grid element, whose thickness may be equal to or greater than that of the latter, on both sides of the central rim, in order to provide greater resistance to bending and minimize the distortion produced by the passage of the product through the grid, especially when it comes to a grid of parallel blades with open longitudinal passages;
When it comes to a central grid element designed to cut the product in strips, the blades arranged in parallel form open passages;
Optionally, the perimeter of the grid includes at least two integrated positioning lugs, also made of a plastic material, obtained during the same over-molding operation, and radially extended from diametrically opposing positions.

In this way, a cutting grid in one piece is obtained, which guarantees a perfect performance during its use once incorporated in the interior of a vegetable cutting machine or a kitchen robot.

Understandably, the size of the openings of the grid's framework, or the separation distance between parallel blades of open longitudinal passage, will vary depending on the desired size of the squares or cubes, or the vegetable elongated strips to be obtained.

### SHORT DESCRIPTION OF THE DRAWINGS

These and other features and advantages of the invention will be more clearly apparent from the following detailed description of a preferred embodiment of the invention, given only as an illustrative and not limiting example, with reference to the drawings that accompany it, in which:

FIG. 1 is a schematic view, in perspective, of a cutting grid of the present invention that shows the constituent parts of the grid in its two configurations of quadrangular or parallel opening framework;

FIG. 2 is a schematic view of a cutting grid with a reinforcement metal rim embedded in the outer perimeter during the overinjection of the plastic material that makes up the perimeter as well as the metal rim itself.

FIG. 3 is a schematic view, in perspective, of a central cutting grid element seen from its bottom.

FIG. 3a illustrates a detail of the coupling among the cutting blades of the central cutting grid element in FIG. 3.

### DESCRIPTION OF A PREFERRED EMBODIMENT

As it has been mentioned above, the detailed description of the preferred embodiment of the object of the invention is to be carried out below with the help of the attached drawings, through which the same numerical references to designate equal or equivalent parts are used.

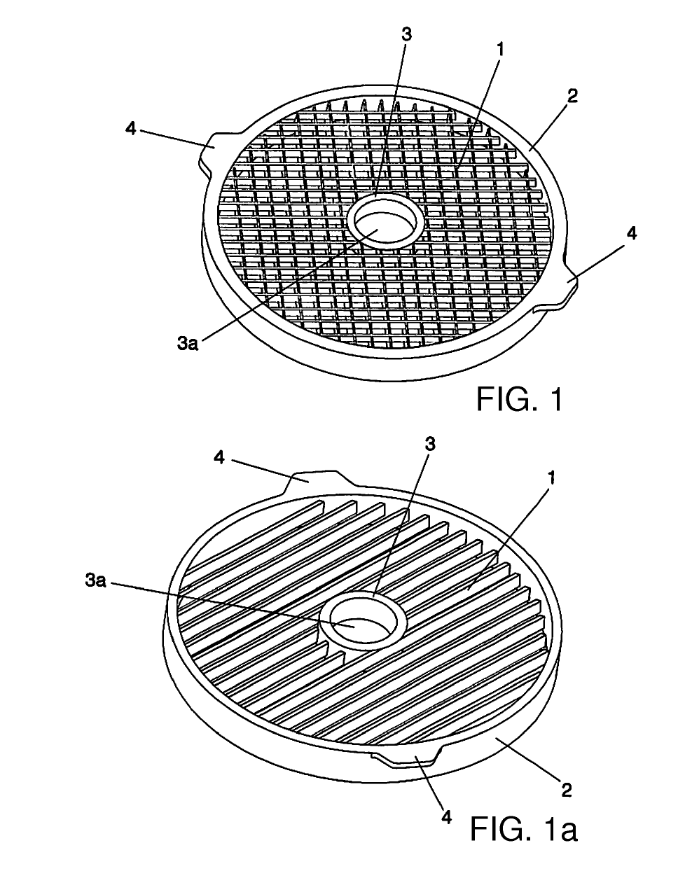

Thus, taking into account in the first place the representation in FIG. 1, a schematic view, in perspective, of the components that make up the vegetable cutting grid of the invention, is shown. According to said representation, the cutting grid is composed by a central cutting grid element 1, of a metal nature, which, as it can be seen, is of a circular shape as usual, and is composed by a multiplicity of blades that together form a framework of squared openings to cut the vegetables in cubes or in a longitudinal shape, leaving the framework a central hole la properly formed, and a frame composed by two rims of a plastic material, one of which is indicated by numerical reference 2, it is of a circular shape and a predetermined height and constitutes an external perimeter, and the other one, indicated by numerical reference 3, is the central rim and is complementary configured with hole la of the central cutting grid element 1, in which is attached. The central rim 3 has an axial hole 3a for the attachment of the drive shaft of the cutting disc (not represented).

All of the components of the cutting grid of the invention shown in FIG. 1 represent a whole unity because the rims 2, 3 which form the plastic frame are obtained through molding by overinjection directly on the central cutting grid element 1, in a way that once the plastic material is cooled, rims 2, 3 of the frame and the central cutting grid element 1 are fixed.

Optionally, the external perimeter 2 has at least two integrated lugs 4 formed during the same overinjection operation, radially extended outwards from diametrically opposing positions, and which can take various configurations. The lugs 4, regardless of the configuration they adopt, are all positioning means that maintain the whole of the cutting grid in its operational position in the interior of the machine, without the possibility of rotating.

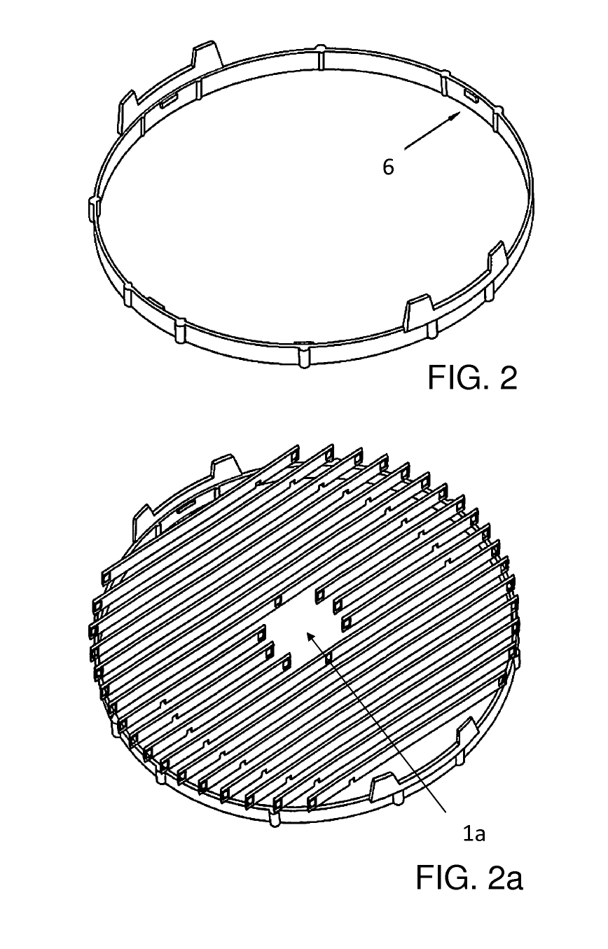

Now referring to FIG. 2, because the length of the blades may be regarded as fairly significant, it is possible that the retraction of the plastic material of the outer perimeter 2 of the plastic material frame can lead to unwanted bends in said blades, even with the use of a plastic material that has a small retraction. To avoid this problem, the invention has provided for the inclusion of an inner metal rim 6, embedded in the plastic material of the outer perimeter itself 2, so that the retraction is minimal. This rim 6, of a metal nature, preferably aluminium, prevents the retraction and allows the blades of the central cutting grid element 1 to have no arching or sagging. This rim 6 has reinforcements of the same metal material distributed around its outer perimeter so that the danger of sagging by the retraction of the injected plastic material is eliminated.

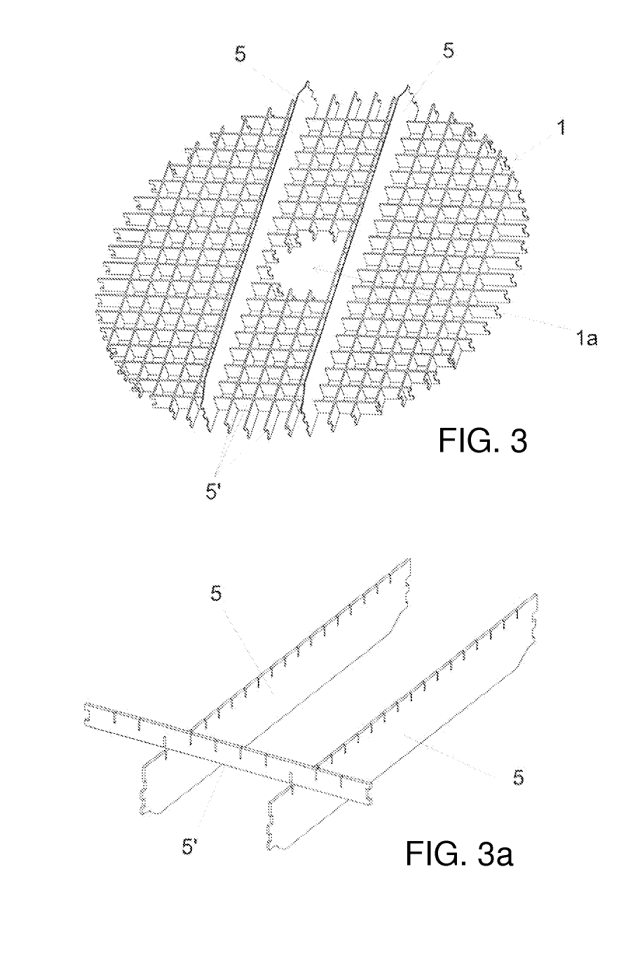

FIG. 3 shows a schematic representation of a central cutting grid element 1 seen from the lower face. As it has been mentioned throughout this description, two blades placed on both sides of the central rim (and therefore on both sides of the central hole la of the central cutting grid element), are of a considerably larger height than the rest of the longitudinal or transverse blades 5′ that make up said central cutting grid element 1, and whose thickness can be optionally the same or greater than that of the latter. This height difference is an effective reinforcement against the unwanted bending of the central cutting grid element 1 when this is pressed with the food that is going to be cut up as it goes through its openings. The detail in FIG. 3a illustrates with greater clarity the comparative difference existing between the height of both blades 5 and the height of the rest of the longitudinal or transverse blades 5′, as well as the coupling by virtue of complementary partial slots carried out in the blades. Also, the detail in FIG. 3a illustrates the ends of the blade 5′ equipped with notches for the introduction of the plastic material of the outer perimeter 2 during the molding overinjection operation, in order to obtain a strengthened joint among all the blades of the central cutting grid element 1 and said outer perimeter 2. The same applies to the joint between the central rim 3 and the inner ends of the blades that lead into the interior of hole 1a.

Although the description carried out corresponds only to a preferred embodiment, it will be understood that, within its essentiality, many changes and variations in detail could be introduced, also comprised within the scope of the invention, and in particular may affect characteristics such as shape, size, or certain types of materials used in the manufacture of the components of the whole, or any other that do not alter the invention as has been described throughout the present specification, and as defined in the claims that follow.

1. Grid for cutting vegetables especially indicated for its use in the interior of a vegetable cutting machine or a kitchen robot in order to cut a previously sliced vegetable by means of a rotating cutting disc and pressed against the grid by that same rotating disc, whose grid comprises a central cutting grid element (1) whose cutting blades are distributed like a framework that leaves squared openings for obtaining squares or cubes from the cut vegetable, or otherwise, they are placed successively in parallel leaving longitudinal spaces open to obtain elongated strips from the cut vegetable, being this central cutting grid element of grid associated to an outer perimeter (2) and a central rim (3) located in a hole (1a) of said central cutting grid element (1), which is characterized in that said central cutting grid element (1) is of a metal nature and the outer perimeter (2) and the central rim (3) are of a plastic material placed directly on the central cutting grid element (1) by means of molding by overinjection, with the respective ends of the cutting blades embedded in the plastic material itself constituent both of the perimeter (2) and the central rim (3), the perimeter (2) being equipped with a reinforcement metal rim (6) embedded in the plastic material itself.

2. Grid for cutting vegetables, according to claim 1, characterized in that two blades (5) of the central cutting grid element (1), located on both sides of the central rim (3) and extended in parallel among themselves, are of a considerably larger height than the rest of the longitudinal and transverse blades (5′) of the framework of said central cutting grid element (1), thus minimizing the eventual deformation produced in said central cutting grid element (1) by the passage of food throughout its openings.

3. Grid for cutting vegetables, according to claim 1, characterized in that the outer perimeter (2) has at least two positioning lugs (4), integral with it, shaped by the same molding overinjection operation, and extended radially outwards from diametrically opposing positions.
